(19) United States
(12) Patent Application Publication
(10) Pub. No.: US 2007/0006516 A1
(43) Pub. Date: Jan. 11, 2007

(54) Waterfowl retrieval device

(76) Inventor: Leslie Leonidas LaCroix JR., Monroe, LA (US)

Correspondence Address: Leslie Leonidas LaCroix, Jr., 3111 River Oaks Dr., Monroe, LA, 71201, US

(21) Appl. No.: 11/481,452

(22) Filed: Jul. 6, 2006

Related U.S. Application Data
(60) Provisional application No. 60/697,916, filed on Jul. 11, 2005.

(51) Int. Cl. A01M 31/00

(52) U.S. Cl. 43/26.1

(57) ABSTRACT

The present invention provides for a remotely controlled water borne device to retrieve downed waterfowl. The device is shaped as a catamaran styled boat with twin hulls to allow the water and debris to flow through the device rather than under the device. The device is propelled through the water with twin electric airplane motors and propellers powered by onboard battery packs to prevent vegetation and other debris from becoming entwined on any underwater appurtenances. The device is steered by a remote control transmitter which turns the direction of the electric motors themselves rather than having rudders which can be affected by the atmospheric wind. The speed and direction of the device are variable by the use of the remote transmitter. The device is outfitted with a retrieval basket which rotates in an up and down position by remote control to retrieve the downed waterfowl. The downed waterfowl is then either returned to the hunter for removal or deposited by the hunter at a location chosen by the hunter without the hunter having to touch the device or the downed waterfowl.

### CROSS REFERENCE TO RELATED APPLICATION

The current application claims the benefit of the previously filed provisional patent application filed by the same inventor on Jul. 11, 2005, Application No. 60/697,916, Confirmation No. 9519.

### BACKGROUND OF THE INVENTION

From the time waterfowl hunting began, the hunter, after having downed a waterfowl, either had to personally retrieve the waterfowl or use a retriever dog. If the hunter had to personally retrieve the downed waterfowl this would require considerable effort and energy of the hunter as well as certain risks of falling in the water and thereby canceling the hunt. If the hunter used a retriever dog the hunter would be required to purchase the dog, train the dog, care for the dog both medically and none and carry the dog to the hunting location. Both methods, with today's technology, appear outdated.

The present invention relates to the use of a device, rather than the above methods, in which the hunter uses a hand held radio transmitter device to send out the retrieval device to retrieve the downed waterfowl.

1. Field of the Invention

The field of this invention relates to a combination of electronic and mechanical devices for retrieving downed waterfowl. Through the use of radio remote control the user can effectively retrieve downed waterfowl in open water and return the downed waterfowl to the user or his hunting station without the user having to leave same or touch the device or waterfowl.

2. Description of the Prior Art

Several prior art devices relate to the present invention. As can be seen, they do not incorporate many of the designs and improvements of the present invention.

U.S. Pat. No. 3,026,545 issued to Brainard utilizes a single hull, motor, underwater propulsion propeller and a rudder for steering. A remote control device guides the device toward the downed waterfowl which is then pushed through the water by projecting arms attached to the device back to the hunter.

Several inherent limitations exist in the Brainard device. The projecting arms of the Brainard device do not lift the downed waterfowl from the water, thereby causing steering problems of the device and additional drag on the device through the water. The projecting arms, underwater propeller and rudder can become caught in weeds and vegetation thereby making the device difficult to steer or prevent any movement of the device through the water.

The present invention is different from the Brainard device in many areas. The twin catamaran hulls of the present device allow sticks, weeds and vegetation to flow through the device thereby eliminating any drag on the device. The twin electric motors on which are mounted hobby airplane propellers push the present device through the water with no underwater members thereby eliminating any drag on the device. The present invention includes a centered wire basket which is open in the front which lowers beneath and above the water surface by remote control. By maneuvering the present device inline with the downed waterfowl the basket can be lowered at the opportune time and with forward movement of the device the basket can then be raised along with the downed waterfowl clear of the water's surface. Further, the Brainard device provides no means for reversing the device in the water. The present invention provides an easy method for reversing the device in the water by the use of the remote control transmitter. The ability to reverse the device in the water is particularly useful in aligning the device with the downed waterfowl to enable a retrieve and to maneuver the device around trees, bushes or stumps which may be in the water. Of particular usefulness, the reverse mechanism allows the hunter to retrieve the downed waterfowl and deposit the waterfowl at a chosen location by lowering the basket into the water and applying reverse to the device. In this manner the downed waterfowl is released from the basket without the hunter ever having to touch the device or the waterfowl. For example, the hunter can easily make a “U” shaped station to deposit downed waterfowl from logs, tree limbs or other material which with the aid of the wind will keep the downed waterfowl in place until the end of the hunt.

Another prior art which is similar to the present invention is the patent issued to Cicoff, et al, U.S. Patent No. 20030061754 which provides for a remote control game decoy and game retriever device. The Cicoff device consists of a duck decoy shaped device which is propelled through the water by the use of either a motor driven underwater propeller or a water jet propulsion system. The device is maneuvered by the use of an underwater rudder or directionally controlled nozzle attached to the water jet propulsion system. The Cicoff device is controlled by the use of a remote control radio transmitter and receiver. The Cicoff device retrieves downed waterfowl by the use of a snare hook mechanism or a plurality of tines which extend from the rear portion of the decoy device by means of a spool of line which grasps the downed waterfowl. The device then drags the snared waterfowl through the water to the user of the device.

There are several inherent limitations of the Cicoff device. As in the Brainard device, the Cicoff device uses either an underwater propeller and rudder or a water jet propulsion system. As described above, the underwater propeller and rudder system allow the device to become caught in weeds and vegetation in the water which can cause drag on the device or prevent the device from maneuvering in the water. Further, the water jet propusion system which projects from the underside of the decoy device can cause the same problems or the water intake of the jet propulsion system can ingest such weeds or vegetation thereby causing it to malfunction.

Another limitation of the Cicoff device is in the retrieval system. As stated, the Cicoff device utilizes a system of a spool on which line is attached located at the rear of the duck decoy. The line is deployed by the use of remote control at the end of which line is attached a snare hook or tines to attach to the downed waterfowl. The methods of attachment of the hook or tines to the downed waterfowl from the rear of the device are not fully apparent. Further, this method would allow the downed waterfowl being dragged by the device through the water to become caught in vegetation or debris in the water and thereby hamper maneuverability of the device or cause the downed waterfowl to become dislodged or unattached to the device. Further, the additional drag of the downed waterfowl being dragged behind the device would also hamper maneuverability or cause loss of movement of the device.

The present invention does not teach the use of an underwater propeller and rudder system or the underwater jet propulsion system which can become entwined in weeds or vegetation or ingest same into the intake of the water jet propulsion system. Rather, the present invention utilizes no underwater propulsion system which can cause the above problems and limitations. The present invention teaches the use of twin hobby electric airplane motors and propellers which are affixed upon the cross member platform at the rear of the twin catamaran hulls. In this method, the propulsion of the present invention is provided solely by the forward or reverse rotation of the motors by the use of remote control. Steering of the present invention is made by the use of hobby radio controlled servos attached directly to the motors which provides for 120 to 140 degrees of rotation of both electric motors simultaneously. In this method the present invention can be steered in either forward or reverse by the use of the remote controlled transmitter and without the need for large air rudders to deflect the direction of the wind developed by the propellers. As a further explanation of this embodiment of the present invention, the steering direction of the present device is accomplished by the actual rotation of the body of the electric motors themselves rather than upon a dependent rudder mechanism. By the rotation of the electric motors by remote control in either direction the stern or rear of the device proportionately turns depending upon the degree of rotation of the electric motors thereby changing the direction of the device.

The present invention further teaches the use of a retrieval basket which pivots up and down by the use of remote control. The retrieval basket is affixed to the front of the platform and amid and between the two catamaran hulls. The retrieval basket is raised and lowered by two high torque servos to which are attached long servo arms. The servo arms are then attached to the rear cross member support of the basket which slide laterally upon such cross member support. As the servos and attached servo arms rotate by the use of remote control the servo arms project toward the basket thereby raising the basket from the water surface. As the reverse mechanism is utilized by the use of remote control the servo arms rotate back and away from the basket thereby lowering the basket into and beneath the water surface allowing retrieval of the downed waterfowl. The retrieval basket is held in place in either the raised or lowered position by the tension of the two servos and attached arms thereby keeping the basket in position so the downed waterfowl will not become dislodged. The above described method of retrieval prevents the downed waterfowl and any part of the device from becoming entwined in weeds and vegetation during the retrieval of the downed waterfowl.

Another prior art device which is similar to the present invention is the patent issued to Saunoris, et al, U.S. Patent No. 20040025770. The Saunoris device teaches the use of a remotely controlled water-borne vessel in the shape of a duck decoy which device is propelled through the water by the use of an electric motor(s) and underwater rudder(s) and screw propeller(s). The device further teaches the use of retrieval of the downed waterfowl by the use of prongs attached to the front of the decoy device. In this manner the device is remotely steered toward the downed waterfowl and the forward extending prongs grapple the downed waterfowl with forward movement of the device. The device then remotely pushes the downed waterfowl back to the hunter for retrieval.

The Saunoris device has several limitations as described above. The propulsion and steering mechanism would allow weeds and other vegetation to become entwined thus creating drag on the device or preventing further movement of the device through the water. Further, the retrieval grappling prongs of the device are rigidly affixed to the body of the device which allows only the downed waterfowl to be pushed through the water to retrieve. The use of such prongs would not allow a downed waterfowl to be lifted from the water surface and would cause additional drag on the device through the water, as well as such prongs could become entwined in weeds and vegetation from the additional weight of the downed waterfowl. Further limitations would include that the device could not be propelled in reverse for improved steering as the floating downed waterfowl would become dislodged from the prongs by the reverse movement of the water. Additionally, retrieval by the hunter would require removal of the downed waterfowl by the hunter from the prongs of the device which would extend the retrieval process.

The present invention as described above does not teach the use of any underwater propulsion or steering mechanism which could become lodged in weeds and vegetation and create drag on the device through the water. Rather, the present invention teaches the use of electric hobby airplane motors and propellers which propel the device in forward or reverse by the means of air propulsion. The present invention does not teach the use of retrieval of the downed waterfowl by pushing or dragging the downed waterfowl through the water but by the means of a remotely controlled retrieval basket which raises the downed waterfowl from the water surface to be retrieved by the hunter. The present invention further does not teach the use of removal of the retrieved down waterfowl by the hunter but rather by the raising or lowering of the retrieval basket by remote control by the hunter to a location designated by the hunter. The hunter may also have the option to physically remove the downed waterfowl from the retrieval basket if the hunter so choses.

Another prior art which is the most similar to the present invention is the patent issued to Becherer, U.S. Pat. No. 4,545,315. The Becherer device consists of a water borne remote control device, including a pair of pontoon members for floatation with a scoop centered between said pontoons for retrieval of the downed waterfowl. The device is propelled through the water by the means of an electric propulsion motor with an underwater propeller and rudder assembly.

There are several limitations of the Becherer device one of which is the above described underwater propulsion and steering mechanism. Such mechanisms do not lend themselves to the mixed terrain of waterfowl hunting. Invariably, there exist certain algae, weeds and other vegetation in the water which the waterfowl may digest for food and natural concealment from hunting. The Becherer device does not teach the use of avoiding such underwater mechanisms which obstruct the propulsion of the device through the water rather than to facilitate it. The Becherer device further describes the propulsion motor as a trolling motor type which could easily become fouled in weeds and other debris in the water. The remote control circuitry of the Becherer device teaches the use of a series of electronic relays and solenoids for activation of the various controls of the device which could appear complicated to the user even considering the date of the invention. Further, although the scale of the Becherer device is not fully described, the device appears to utilize the use of a 12 volt automotive type battery for propulsion power. Such batteries tend to be in the 30 to 50 pound range which would make the the final device extremely heavy and difficult for the hunter to carry to the hunting location. Such additional weight would also make the device sink lower into the water thereby causing loss of propulsion power and causing additional entanglement with weeds and vegetation. The present invention can reach speeds up to 15 m.p.h.

The scoop retrieval mechanism of the Becherer device, although utilizing the raising and lowering of the scoop to retrieve the downed waterfowl from the water, utilizes a web type assembly of fish-type line attached to the tubular members of the scoop to help trap the downed waterfowl during the retrieve. Although of good design, such assembly may cause considerable inconvenience to the hunter in trying to extricate the downed waterfowl from such entrapment. Further, such method of entrapment of the downed waterfowl would not allow the downed waterfowl to be unloaded by the device itself and would cause the hunter to extricate the downed waterfowl upon every retrieve.

The present invention as stated above teaches the use and construction of the propulsion and steering of the device to consists of no underwater assembly which could become entwined in debris in the water. Further, the present invention is extremely light weight, 10 pounds, and utilizes state of the art hobby radio control electronics which are compact and user friendly. Today, the typical 12 volt nicad or nickel metal hydride battery pack weighs less than one pound compared to the heavy automotive battery of the Becherer device.

The present invention differs considerably from the Becherer device in the retrieval mechanism. The present device employs a solid frame like wire basket which has the front side open to retrieve the downed waterfowl. The frame type wire basket allows water and small debris to flow through the basket upon retrieval of the downed waterfowl to eliminate any additional weight or drag upon the device and upon raising the basket by remote control creates an angular entrapment of the downed waterfowl without the web mesh method of the Becherer device. Further, such embodiment of the present invention allows the downed waterfowl to be easily removed by the hunter or deposited by the hunter at a designated location for temporary storage of the waterfowl during the hunt by lowering of the basket into the water and reversing the direction of the device without the hunter ever having to touch the device or the downed waterfowl.

### SUMMARY OF THE INVENTION

Thus it can be seen that there is a need for the present invention which has not been incorporated in the prior art. The present invention fulfills all of the objects and advantages of a device which is fast and lightweight and retrieves downed waterfowl from the water with no underwater assembly to entangle the device with weeds and vegetation. Further, the present invention fulfills the need of older or disabled hunters by the use of remote control with the convenience and simplicity of the retrieval of downed waterfowl without the hunter ever having to leave his hunting station or touch the device nor having to purchase, train and maintain a dog to retrieve downed waterfowl. The use of a well trained dog will always be a scenario for hunting birds and waterfowl, however, the present invention will allow hunters the option of not having a dog or adding the present invention in conjunction with the use of a dog.

### BRIEF DESCRIPTION OF THE DRAWINGS

FIG. 1 is a perspective view of the waterfowl retrieval device which is the object of the present invention.

FIG. 2 is a top plan view of the two electric motors and propellers and the rotation of the motors for steering of the present invention.

FIG. 3 is a side plan view showing the pivoting of the retrieval basket above and below the water surface of the present invention and depositing the downed waterfowl at a designated location.

FIG. 4 is a bottom view of the device showing the two servos and arms used to raise and lower the retrieval basket.

FIG. 5 is a top plan view of the basic layout of the electronic radio remote control components and the wireless camera and monitor option of the present invention.

### DETAILED DESCRIPTION OF THE INVENTION

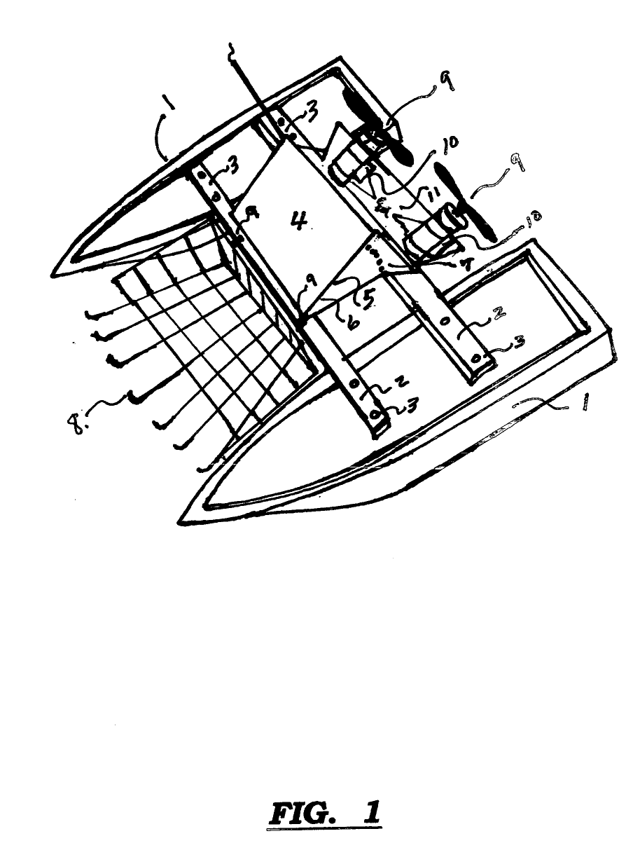

Referring to the drawings, FIG. 1 shows a remotely controlled downed waterfowl retrieval device which is the object of the present invention. The twin catamaran hulls 1 are spaced apart to allow for movement of the water and any debris in the water through the twin hulls rather than under the hulls. The twin hulls are connected together by the means of PVC rectangular bars 2 which are void in the center to reduce weight. The rectangular bars are connected to the hulls by the means of nylon screws 3 which protrude through the PVC bars and into the top of the hulls. The rectangular bars are also glued to the top of the body of the hulls using ABS plastic glue. The twin hulls 1 are made from ABS plastic which is strong and lightweight. The hulls can easily be purchased from hobby shops or fabricated by a molding process. Between the two hulls is a compartment 4 which holds the electronic components of the remote control device. The compartment 4 rests upon the two rectangular bars 2 for support and is attached to the bars by nylon screws. The front of the compartment consist of a flap 5 which opens forwardly to allow access to the inside of the compartment. The compartment 4 is constructed from poly foam board, ¼″ thick, which is strong and lightweight and can be purchased easily from department stores or school supply stores. The compartment 4 has two angular sides 6 which allow the device to move more easily against the wind. The rear side 7 of the compartment 4 only extends to one half of the height of the rear side to allow for ventilation of the compartment to prevent the electronic components from overheating.

Located between the front of the twin hulls is a basket 8 which is used to retrieve and hold the downed waterfowl in place during the retrieval process. The basket 8 is made from metal bars which may have a plastic coating on the bars to prevent deterioration in the water and atmosphere.

The basket 8 is attached to the front crossmember PVC rectangular bar 2 by two small nylon hangers 9 to allow the basket to pivot from the rear of the basket. The two nylon hangers 9 are attached around the top metal bar of the basket 8 and both remaining ends of the nylon hangers are attached to the front crossmember 2 with nylon screws. The operation of the metal basket 8 is more fully described herein below.

The device is propelled through the water by the use of twin hobby electric airplane motors and propellers 9 which push the device through

the water rather than pull the device as in a conventional airplane. The use of hobby electric, airplane motors allow the device to be propelled by the force of the wind created by the motors and propellers, rather than by the use of an underwater propeller(s) which can become entwined in weeds and other vegetation usually found in waterfowl hunting areas. Steering of the device is accomplished by the use of twin hobby servos 10 which are used primarily in the hobby field to turn rudders and elevate flaps for model airplanes and boats. The two hobby servos 10 are attached to the motors 9 by means of a round or cross shaped horn commonly used in the hobby industry which horns attach to the splined output shaft of the servo. The electric motor 9 then is attached to the top of the horn by means of a hobby motor mount assembly or by use of nylon wire ties 9(a) commonly used by electricians and others to group and hold multiple wires together. The servos 10 and motors 9 combination are then attached to the rear of the compartment platform 11 which extends from the floor or base of the compartment 4 by means of a hobby servo mount or rectangular PVC cut out to accept the body of the servo which is attached to the underside of the platform 11 with nylon screws. The mounting of the twin electric motors must be rigid and strong to withstand the rotational force generated by the motors and propellers which can exceed 16,000 rpm. The steering operation of the device is more fully explained herein below.

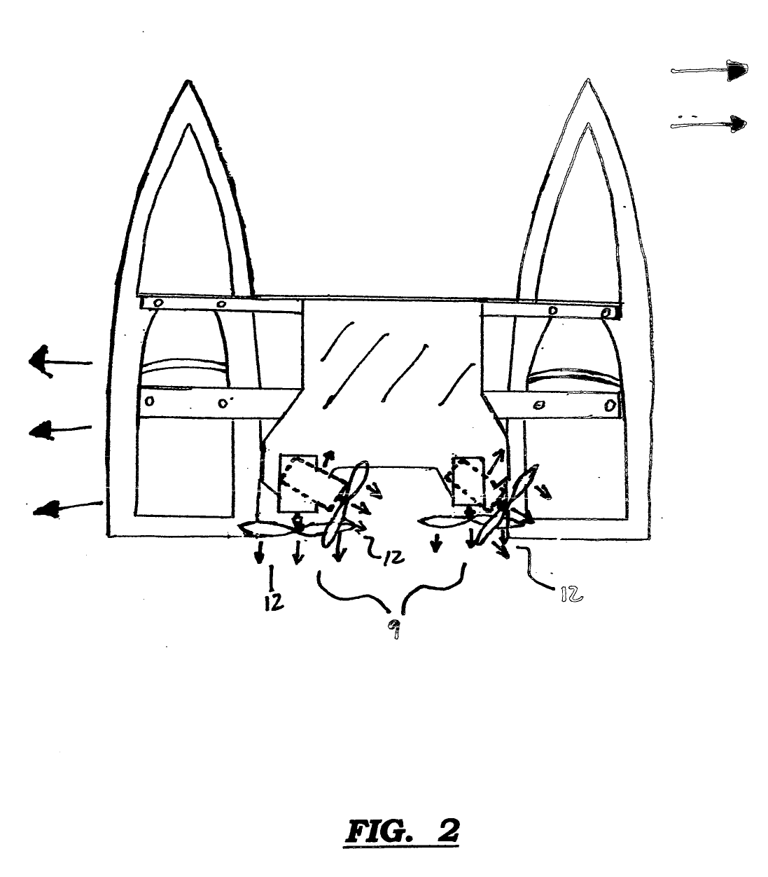

Referring to FIG. 2 of the device shows a top plan view of the rotation of the twin hobby electric airplane motors and propellers 9. The twin motors and propellers 9 rotate simultaneously in either a clockwise or counter clockwise rotation by the use of the remote control radio transmitter more fully explained herein below. As the steering knob of the remote control transmitter is turned by the thumb of the user in either direction a radio signal is transmitted to the receiver onboard the device which receiver then transmits the signal to the servos 10 in the form of an electrical pulse which rotates the output shaft of the servos and attached motors in corresponding directions 12. By applying no rotational force by the user to the steering knob of the transmitter the servos and attached motors remain in a constant or neutral forward direction thereby eliminating constant manipulation of the transmitter unless another direction of the device is desired. By rotation of the motors in either direction the force of wind produced by the propellers propels the stern or rear of the device in the opposite direction thereby rotating the bow or front of the device in the direction chosen by the user. The rotation of the motors in either direction is proportionate to the amount of rotation applied to the steering knob of the transmitter by the user. In this manner, a slight rotation of the steering knob of the transmitter by the user produces a corresponding rotation of the motors which in turn produces a slight turn of the device in the chosen direction. Similarly, a severe turn of the steering knob of the transmitter by the user produces a corresponding rotation of the motors which in turn produces a severe turn of the device in the chosen direction.

Therefore, a preferred embodiment of the present invention, not addressed by any prior art, is the ability of the device to steer without the need of underwater propellers or rudders which can become entwined in weeds and vegetation in the water. Another preferred embodiment of the present invention not address by prior art is the ability of the device to steer by the direction of the motors and propellers only and without the use of air rudders as seen on many air boats. The ability to steer the device without the use of large rudders to deflect the angle of the wind force produced by the motors and propellers greatly improves the maneuverability of the device in the water. Large rudders behind the propellers and motors would themselves catch a large amount of atmospheric wind and tend to push the stern or rear of the device in the direction of the wind and which also could be counteractive to the direction chosen by the user. Further, the air space located between the propellers and rudders results in inefficiency for steering as this space allows atmospheric wind to enter the space and further distort the chosen steering direction of the user. The elimination of the rudders also reduces the overall weight and increases handling capability of the device by the user.

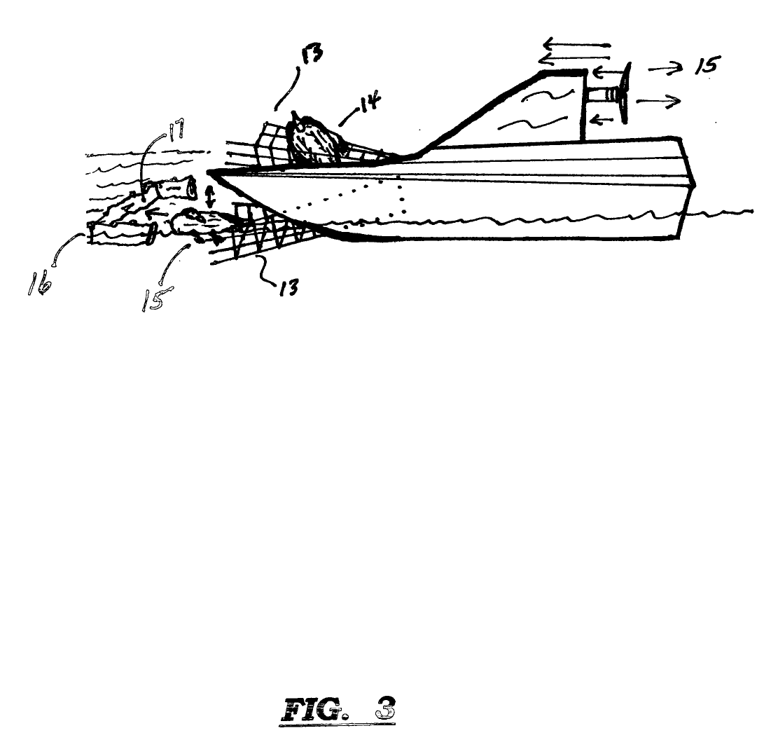

Referring to FIG. 3 of the device shows a side plan view of the rotation of the retrieval basket in an up and down position 13. The upward rotation of the basket allows the device to traverse through the water without any underwater assembly to obstruct the travel of the device or allow the device to become entwined in weeds and other vegetation. Also, it allows the downed waterfowl a resting position in the basket which prevents the downed waterfowl from falling out of the basket during the retrieval process 14. Correspondingly, a lowered position of the basket allows the hunter to scoop up the downed waterfowl by forward movement of the device 15 and upon the downed waterfowl being within the basket to raise the basket to capture the downed waterfowl 14. A preferred embodiment of the present invention which has not been addressed by any prior art is the ability of the device to retrieve downed waterfowl and then deposit the downed waterfowl at a location chosen by the hunter. The ability of the device to deposit downed waterfowl at a given location greatly minimizes the time required by the hunter to extricate the downed waterfowl from the device. FIG. 3 shows a downed waterfowl which has been retrieved into the basket being deposited by the device by the hunter into a depository station 16. The depository station can be easily constructed by the hunter in the field by using logs, limbs or other vegetation found at the location by the hunter. The hunter could also easily build a depository station with wood or other suitable material at his home or shop and provide some means of flotation in the water. The depository station could then be brought to the hunting location and anchored into place with weights.

The deposit of the downed waterfowl is accomplished by the hunter using the remote control transmitter of the device. Once the hunter has successfully retrieved the downed waterfowl into the basket and raised the basket to trap the downed waterfowl therein, the hunter then directs the device toward the depository station. As the device approaches the depository station the hunter then lowers the retrieval basket and reverses the direction of the device. The downed waterfowl is thus released from the retrieval basket and deposited into the depository station 17. By choosing the location of the depository station with the open side facing the wind the deposited downed waterfowl will remain in the station until the hunter picks up the waterfowl at the end of the hunt. The hunter could also place small branches or limbs in front of the depository open side which would prevent the downed waterfowl from being blown from the depository in the event of a change in the wind direction.

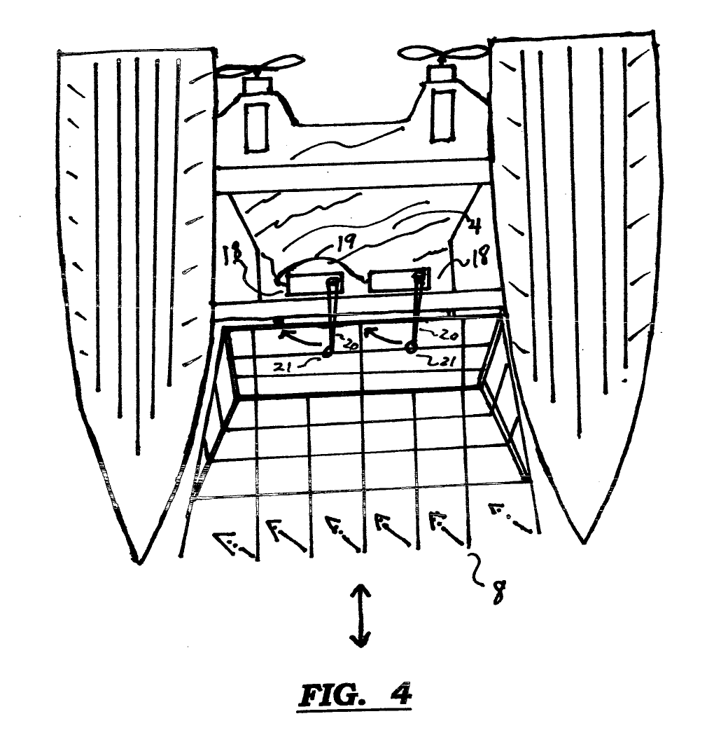

Referring to FIG. 4 shows an underside view of the present device and the operation of the retrieval basket 8. The up and down rotation of the retrieval basket is accomplished by the means of two hobby servos 18 mounted to the underside of the compartment 4. The two servos can be mounted by the use of hobby servo mounts prevalent in the hobby industry or by the use of cut out PVC rectangular bars to hold the servos in place with screws. The two servos 18 should be of the heavy duty or high torque type each capable of lifting five (5) pounds of weight or by the addition of a servo gear box which greatly increases the torque of the servo. The operation of the two servos is accomplished by the use of the remote control transmitter which contains a shift button (channel 3) normally used to shift gears in remote controlled cars. The shift button which is depressed by the user sends a radio signal to the receiver aboard the device which in turns sends an electrical pulse to the twin servos simultaneously by the use of a Y harness 19. The output shafts of the two servos then rotate simultaneously in either a clockwise or counter clockwise rotation depending upon the alternate depression of the shift button by the user. Attached to the splined ends of the output shafts of the two servos are two large hobby servo arms 20 common in the hobby industry. The two servo arms are attached to the retrieval basket 8 by the means of electrical nylon fasteners or clamps 21 which attached around one of the lateral metal bars of the rear of the basket. The two nylon fasteners or clamps are then attached to the ends of the two servo arms with a small nylon bolt and nut and tightened enough to allow for ease of movement of the clamps upon raising and lowering of the retrieval basket. However, the metal lateral bar used to attach the two servos to must be lower than the top lateral metal bar of the basket which is the pivotal bar to allow the basket to rotate.

As the servos are activated by the transmitter signal the two servo arms rotate simultaneously. The two large servo arms produce a pendulum type rotation 21(a) in which the ends of the servo arms extend further forward upon activation and retract to a lesser extent or parallel with the basket upon opposite activation. In this manner, the servo arms propel the basket either in a forward and upward position for travel through the water with or without the downed waterfowl or in reverse or downward position for retrieval of the floating downed waterfowl or the depositing of the downed waterfowl in a location chosen by the hunter. The retrieval basket is held in either an up or down position by the tension supplied by the two servos until they are activated in an opposite direction by the transmitter.

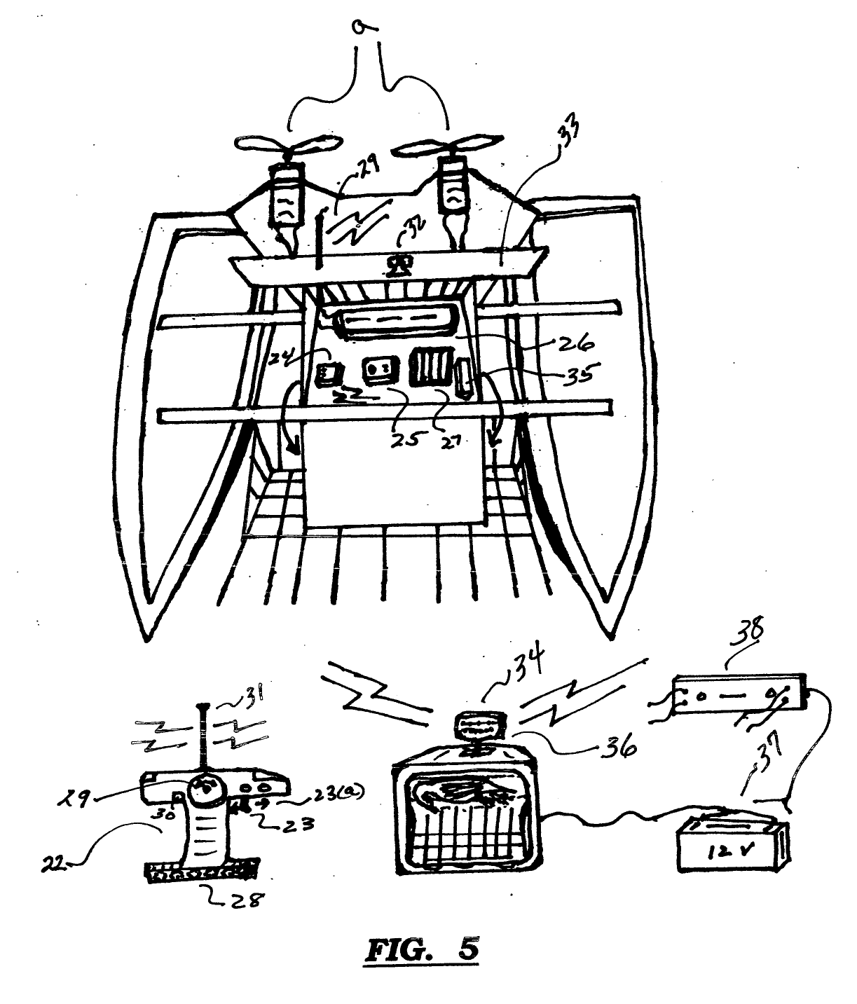

Referring to FIG. 5 of the present invention shows a top plan view of the radio remote control devices and the wireless camera and monitor option and alternate embodiment of the present invention.

The overall direction of the device in either forward, stop or reverse is provided by the means of the transmitter 22. The hobby style transmitter 22 which is readily available through hobby stores provides a throttle lever 23 which is controlled by the user's left index finger. A backward pull on the throttle lever 23 transmits a radio signal to the hobby receiver 24 of the device which in turns transmits an electrical pulse to the hobby speed controller 25. The speed controller 25 then transmits electrical voltage which is supplied by a 12 volt battery pack 26 to the two electric airplane motors 9. The speed of the device is determined by the amount of force applied to the throttle lever 23. A slight pull of the throttle lever 23 by the user produces a slow forward direction. A hard pull of the throttle lever 23 by the user produces a fast forward direction.

A reverse direction of the device is accomplished by the user applying a forward force of the throttle lever 23(a) with his left index finger which in turn reverses the signal transmitted to the receiver 24 and speed control 25 which reverses the direction of the two hobby airplane motors and attached propellers 9. The reverse speed of the device is proportional to the amount of forward force applied by the user to the throttle lever 23.

Electrical power is provided to the receiver 24 by a 6.0 volt hobby battery pack 27. The receiver battery pack 27 consists of five (5) 1.2 volt cells of the nickel cadmium (nicad) or nickel metal hydride (nimh) type readily available at hobby supply stores. The electronic speed controller (ESC) 25 may provide a built in electrical source to provide voltage to the receiver 24. This electrical voltage source provided by the speed controller 25 is termed a “battery elimination circuit” (BEC) which derives its electrical power from the 12 volt battery pack 26 to which it is connected. This electrical voltage provided by the (BEC) is then reduced internally by the speed controller to normally 4.8 volts to supply electrical power to the receiver 24. The purpose of the BEC is to eliminate the requirement of having an additional battery pack 27 to supply power to the receiver 24.

However, in the present device the electrical voltage, 4.8 volts, supplied by the BEC is not sufficient voltage or amperage, usually 1.0 amps, to provide electrical power to the receiver 24. The receiver transmits whatever electrical power that is supplied to it to the two servos 10 which rotate the electric airplane motors and the two high torque servos 18 which raise and lower the retrieval basket 8. Therefore, the electrical wire which comes from the ESC 25 to the receiver 24 must be cut and eliminated by the user. In its place, the 6.0 battery pack 27 is plugged directly into the receiver power supply port to produce sufficient voltage.

If insufficient electrical power is not provided to the receiver 24 the servos 10 and 18 will glitch and chatter and will not operate the servos properly.

Referring to FIG. 5, the transmitter 22 provides all of the radio electrical signals which control the present invention. Electrical power is supplied to the transmitter 22 by internal batteries 28 of the nicad or nimh type and are rechargeable.

Dependent upon the control function chosen by the user the transmitter transmits a radio signal to the antenna 29 of the device. The antenna 29 then transmits the corresponding signal to the receiver 24 to which it is connected. The range of modern hobby transmitters and receivers is approximately 1500 feet which is more than sufficient for the hunter to retrieve downed waterfowl.

Steering of the present invention is provided by the transmitter 22. The steering knob 29 of the transmitter 22 is turned by the user's left thumb in either a clockwise (right) direction or counterclockwise (left) direction. The transmitter 22 then transmits the corresponding signal to the antenna 29 of the device and then to the receiver 24 which in turn transmits electrical power to the two servos 10 which rotate the electric motors 9 in the corresponding direction.

The retrieval basket 8 of the present invention is controlled by the user by pressing the shift button 30 on the transmitter 22 with the user's left thumb. By pressing the shift button 30 the transmitter 22 transmits a radio signal to the antenna 29 of the device which is then transmitted to the receiver 24 which in turn transmits electrical power to the two servos 18 to raise or lower the retrieval basket 8. By alternately pressing the shift button 30 the user can choose between the up or down position of the retrieval basket. The transmitter 22 also provides an antenna 31 which is telescopic which transmits the radio signals to the receiver antenna 29.

Another preferred embodiment of the present invention is the ability of the device to retrieve downed waterfowl beyond the line of sight of the hunter. A wireless video camera 32 is attached by velcro to the top wing 33 of the device. The wireless video camera 32 transmits a forward looking picture to a small television monitor which the hunter can locate in his hunting blind or boat. A video transmitter 35 is located in the compartment 4 which transmits the live video picture to a receiver 36 which is attached to the monitor 34. The camera and transmitter receive their electrical power from the same 12 volt battery pack 26 which supplies power to the electric motors 9. The monitor 34 receives its electrical power from a small 12 volt motorcycle or lawnmower battery or from a spare 12 volt battery pack 26 which operates the two electric motors 9.

With the use of the wireless video camera assembly the hunter can retrieve a downed waterfowl which may have flown too far to be seen or that lands behind trees or brush which puts the downed waterfowl beyond the line of sight of the hunter. The hunter needs only a general location of the downed waterfowl and sends the device to that area to scout for the downed waterfowl. The wireless video camera projects a live picture ten to twenty yards beyond the device while at the same time showing the retrieval basket. After the hunter locates the downed waterfowl while looking at the monitor 34 the downed waterfowl is retrieved by the device in the normal manner by the hunter who guides the downed waterfowl into the retrieval basket shown on the monitor. If the device is not visible to the hunter after the downed waterfowl is retrieved into the basket the hunter retraces the general direction taken to locate the downed waterfowl until the device can be seen visibly by the hunter. The device is then returned to the hunter for removal of the downed waterfowl or the downed waterfowl is deposited in the location chosen by the hunter in the normal manner.

The present invention is powered solely by batteries and therefore the batteries must be in good condition and fully charged during use of the device and its accessories. Multiple battery packs for each required voltage are required for continuous use of the device during the hunt. Since waterfowl retrieval is usually intermittent the device can be used for relatively long periods without interchanging the battery packs. In heavy usage situations two 12 volt battery packs can be connected in parallel to double the run time of the device. The battery packs should be fully charged the night before the hunt at the hunter's home or camp using an equivalent or slightly higher voltage battery charger easily found in hobby and electronic stores. The battery charger must be designed to charge the type of batteries used by the device, either nicad or nimh. Nimh batteries are preferred since they do not retain a “memory effect” such as nicads do, which allows the batteries to be fully charged without first discharging the battery. Also nimh batteries retain their charge for longer periods than nicad batteries.

Since the period of use of the device is unpredictable during a hunt or hunts a Field Battery Charger 38 is used to charge the additional battery packs in the hunter's blind or boat. If the device becomes discharged the hunter simply replaces the discharged battery pack with a fully charged battery pack and the discharged battery pack is connected to the Field Battery Charger 38 to continue the cycle. The Field Battery Charger 38 is portable and is powered by the same 12 volt battery 37 used to provide power to the monitor 34 to eliminate the use of multiple batteries. The Field Battery Charger has two independent charging circuits to charge two battery packs simultaneously and is easily available at hobby supply shops.

Thus there has been shown and described a novel device for the remote control retrieval of downed waterfowl and without the need of a dog. Many changes, modifications, variations and other uses of the device will, however become apparent to those skilled in the art after consideration of the above specifications, descriptions and drawings. Any such changes, modifications, variations and other uses which do not depart from the spirit and scope of the present invention are deemed to be covered herein by the invention which are limited only by the specifications and descriptions above and the drawings which follow.

We claim:

1. A waterfowl retrieval device which retrieves downed waterfowl by the use of a combination of electronic and mechanical devices and which utilizes two catamaran type plastic hulls, one on each side of a compartment to house the electronic devices used to steer and propel the device.

2. A waterfowl retrieval device which utilizes a metal basket on each side of which is a catamaran type plastic hull, which metal basket rotates or swivels in an up or down direction by use of electronic radio controlled servos in order to retrieve the downed waterfowl from the water. The rotation of the metal basket allows the basket to be retracted in an upward direction and out of the water for the propulsion and steering of the device and the retraction in a downward direction and into the water for the retrieval of the downed waterfowl; and the retraction of the metal basket along with the downed waterfowl in an upward direction for propulsion and steering of the device back to the user for the retrieval of the downed waterfowl by the user. Further, the rotation of the metal retrieval basket allows the user to deposit the retrieved downed waterfowl in any location chosen by the user by retracting the basket and downed waterfowl into the water and reversing the direction of the device which then deposits the downed waterfowl into the water at a location chosen by the user.

3. A waterfowl retrieval device which is propelled through the water by the use of two (2) hobby electric motors and airplane propellers which are attached to the rear of the device which forces applied push the device through the water rather than pull the device as in a conventional airplane; which system further propels the device to be propelled through the water by the force of the wind created by the motors and propellers rather than by the use of an underwater propeller(s) which can become entangled in weeds and vegetation usually found in waterfowl hunting areas. Steering of the device is accomplished by the use of two (2) hobby servos which are attached to the electric motors which servos rotate the two electric motors simultaneously in either a clockwise or counter clockwise direction by the use of a remote control radio transmitter; rotation of the motors in either direction the force of the wind produced by the propellers propels the stern or rear of the device in the opposite direction thereby rotating the bow or front of the device in the direction chosen by the user. As a further embodiment of the claim is the ability of the device to steer without the use of large rudders to deflect the angle of the wind force produced by the motors and propellers; which rudders would themselves result in the inefficiency for steering as the space between the propellers and the rudders allows atmospheric wind to enter the space and distort the chosen direction of the user; further the use of rudders would themselves catch a large amount of wind and tend to push the stern of the device in the direction of the wind which would be counter active to the direction chosen by the user.
